(19) United States
(12) Patent Application Publication
(10) Pub. No.: US 2005/0217448 A1
(43) Pub. Date: Oct. 6, 2005

(54) Laser illuminator for indicating a saw kerf and kerf location on a power saw

(76) Inventor: Thomas E. Walker, Georgetown, KY (US)

Correspondence Address: Laurence R. Letson, P.O. Box 910567, Lexington, KY, 40591, US

(21) Appl. No.: 10/713,987

(22) Filed: Nov. 14, 2003

(51) Int. Cl. B26D 7/27

(52) U.S. Cl. 83/521; 83/522.11

(57) ABSTRACT

A laser light is focused through a first lens to a spot, defocused to a spot with a known diametral dimension, and then passed through a second rotatable lens having a first surface comprising a plurality of corrugations in the form of a sinusoidal curved and a second planar surface to produce a line of light of controlled width. The line of light is disposed to illuminate the kerf in a workpiece on a power saw. The line of light may be rotated and translated laterally to align it with the saw blade and, prior to cutting the workpiece, to illuminate the location of the kerf on the workpiece as well as the dimension of the width of the kerf.

### FIELD OF THE INVENTION

This invention relates to the use of a laser and lenses to project a line of light and, more particularly, to the use of a laser and lenses to indicate the location and width of the cut or kerf prior to cutting the workpiece by the projection of a line of light that is the width of a saw blade onto the kerf or where a kerf would be formed below a saw blade on a power miter saw, a power compound miter saw or a radial arm saw.

### BACKGROUND OF THE INVENTION

To indicate the kerf or cut of the saw blade on a workpiece, various approaches have been tried. The prior art has taught devices to illuminate the cut location of the power saw or to illuminate the sides of a saw blade so as to cast a shadow on the workpiece to indicate the edge of a cut or kerf formed when the saw is operated. Moreover, the prior art approaches have not indicated the full width of the kerf or used techniques to illuminate both edges of the cut to define the cut or kerf by non-illumination of the kerf.

U.S. Pat. No. 6,481,322 to Bear Hsiung discloses a light source projecting from the cylinder lens of a device to illuminate a straight cutting indication on the article. The description of this article in this subject patent is silent as to how the device is adjusted, how the beam indicates the cutting edge of the saw blade, and the relationship of the kerf and the light beam. Further, this patent does not inform one of ordinary skill in the art how to fabricate a light and light assembly to provide a projected light beam such as is contemplated by this invention.

U.S. Pat. No. 5,285,708 and U.S. Pat. No. 5,375,495 to Donald R. Bosten et al. discloses an optical system which is mounted on a blade shield of a saw shrouding the saw blade for rotation. This technique requires the blade shield to be opened in order for a solid illuminated line to appear on the workpiece.

Additionally, the optical illumination system in the Bosten et al. patents cooperates with the blade by illuminating the sides of the blade with light that is substantially parallel to the blade to create an illuminated line beside the kerf on the workpiece being cut in order to mark the cutting edges of the kerf.

U.S. Pat. No. 5,996,460 and U.S. Pat. No. 6,397,717 B1, issued to Lance H. Waite, illustrate a light positioned above the blade and shining down on the blade such that the light rays are substantially parallel to the plane of the blade. The light has been oriented to reside in a plane parallel to the saw blade, and the saw blade blocks the light path to the work piece such that the light illuminates a portion of the workpiece on both sides of the blade and leaves a shadow on the surface directly in the path of the blade. This arrangement does not illuminate the kerf in the workpiece nor does it provide a kerf illumination where the kerf will be formed once the cutting operation begins.

U.S. Pat. No. 6,035,757 issued to Raymond Caluori et al. teaches a light emitting device which is mounted coaxially with the saw blade and the shaft which rotates the saw blade and rotates therewith. The light is provided through an opening in the housing such that it is positioned on one side of the saw blade and illuminates the work piece with a beam of light that is limited in one direction by the blade, and thus casts light on one side of the saw blade and a shadow under the saw blade. The blade must be rotating for the light to function. Thus the material begin cut is manipulatable only with one hand as the other hand is used to activate the switch of the saw.

Published U.S. Patent Application 2001/0049988A1 applied for by Shigeharu Ushiwata et al. teaches the use of a laser light which is passed through a series of optical elements to produce a line of light for illumination of the work piece in which the kerf is expected to be cut by the blade. The beam in Ushiwata et al. is narrow. The beam is disclosed and taught as having a width insufficient to illuminate the entire width of the kerf of the saw blade and only illuminates one edge of the kerf. The laser light band is such that it does not and cannot illuminate the kerf in its entire width to indicate the location of the kerf.

Published U.S. Patent Application 2003/0097922A1 applied for by Ruey Aou Chen discloses and teaches an indication device mounted on the saw blade and saw motor support member of a compound miter saw at a location where the mounting point is moved toward the workpiece as the saw blade and saw motor is pivoted downward toward the workpiece. The patent application does not teach one of ordinary skill in the art how to align the indicating device with the saw blade to mark the kerf of the saw. Additionally, the device is mounted on an extension arm supported by the shroud of the saw blade, which is subject to vibration, and also is very vulnerable to being knocked or bumped by either the workpiece being placed in the power saw or by the operator during operation of the power saw. These unsolicited movements constantly subject the laser unit to misalignment and or damage. Further, this published patent application is silent on the adjustment of the width of the light beam projected onto the workpiece in order to make the light beam the same width as the saw blade.

The attempts made in the prior art to provide a finite output light beam have focused upon illuminating the outside edge or edges of a cut or kerf and have not clearly illuminated the full width of the kerf on saws of the miter, compound miter and radial arm saw varieties. These types of saws are advantageous users of a projected beam of light to illuminate the kerf of a saw inasmuch as the illumination defines the material removed from the workpiece by the blade.

Where the prior art teaches the illumination beam being located within the kerf of the saw blade, the art is silent on the width of the light beam and how the beam might be adjusted to brightly illuminate the kerf over the entire width of the kerf.

### OBJECTS OF THE INVENTION

It is an Object of the Invention to improve the accuracy of cutting pieces of wood or other materials by marking the workpiece with a light beam to indicate the location of a cut.

It is another Object of the Invention to provide an accurate marking system for the marking of a workpiece of wood or other material for accurate positioning of the workpiece relative to a saw blade of a saw.

It is a further Object of the Invention to illuminate the position of a kerf prior to cutting the workpiece.

It is an additional Object of the Invention to accurately position the laser output over the kerf prior to cutting in the workpiece.

It is still another Object of the Invention to position the elongated light pattern accurately over the position of a kerf prior to cutting in the workpiece.

It is a still further Object of the Invention to rotate the beam of light emanating from the invention relative to the axis of the laser to align the fan of light with the saw blade.

It is yet an additional Object of the Invention to permit maximum flexibility in retro-fitting existing power saws with the invention.

It is yet another Object of the Invention to maintain the width of the bright illumination of the invention without regard to the distance from the light source.

It is still an additional Object of the Invention to spread the beam of light from a laser into an elongated line of light on a surface to mark the entire width of a kerf of the saw blade.

### SUMMARY OF THE INVENTION

The above objects of the invention are accomplished by mounting and confining a laser light inside a mounting box or housing. The laser is supported on and controlled by a lead screw and follower nut assembly. The lead screw is mounted across or transverse to the mounting box or housing and rotates within the confines of the mounting surfaces of the mounting box.

The laser is mounted within a barrel or first collar and the barrel is further mounted within a second collar, rotatable about the axis of the first collar. The first collar is inserted into a second collar and adjusted to defocus the light spot to produce a spot of light of a predetermined size. The first and second collars then are inserted into an orientation barrel. The entire assembly thereafter is inserted into a block which forms the follower nut of the lead screw and follower nut combination.

The follower nut is preferably a block of material with a threaded hole and a further blind hole formed into the block. The block also is provided a passage from the bottom of the blind hole to the outside of the block to pass the electrical wires or leads to the laser therethrough for connection. The holes are orthogonal to each other but do not intersect.

The laser is potted or adhered within its first collar to remain fixed and then inserted into the second collar to the depth necessary to produce a light spot of a predetermined size. This ensures that the optical relationship with a focusing lens in the end of the first collar is maintained at the desired distance from the laser, and the collar-to-collar engagement is such that the output of the laser through the second collar is maintained as a fixed width beam or size. The orientation collar and the beam broadening lens placed in the end of the orientation collar is assured of face-to-face, fixed spacing with the focusing lens placed in the end of the first collar.

The first and second collars may be fabricated as a single collar, if desired, and the laser inserted within the collar. The focusing lens needs to be fixed in the end of the first collar.

The orientation collar is provided with a broadening lens to broaden the spot of light from the focused laser into a fan of light, thereby forming a line of light emanating from the lens. The lens in the orientation collar does not effect the width of the beam and maintains the elongated beam the same width as the spot of light focused on the lens in the second collar.

The laser is connected to a suitable voltage supply of three (3) volts, and the laser projects light onto the focusing lens and the beam spreading lens. The 3-volt supply may be provided by a battery pack or, alternatively. by a conventional transformer/AC to DC converter.

The laser box is mounted on the frame of the power saw such that it is aligned with the saw blade and, thus, with the kerf to be formed in the workpiece by the saw blade. The illumination box provides a small amount of lateral movement upon the operation of the lead screw. This allows the movement of the light fan or light beam to be positioned exactly over the kerf.

The lens in the orientation barrel of the laser holding assembly is provided with a first surface that is formed in a manner to spread light. The lens is shaped such that the first surface of the lens is a sinusoidal wave. The shape of the second surface is planar. The sinusoidal surface of the lens spreads the light in a direction perpendicular to the axis of the ridges of the lens surface while the fact that the sinusoidal shapes are linear in a second perpendicular direction maintains the light beam at a constant width.

A rotational control or lever is used to rotate the orientation lens and the fan of light about the axis of the beam so that it can be aligned with the kerf of the workpiece. This rotational orientation of the beam of light is accomplished by the rotation of the lens of the second barrel. Both the lens and the barrel may be rotated by the lever in order to present a different rotational orientation of the ridges of the lens to the spot of light formed thereon by the focusing lens of the first barrel of the laser assembly.

The spot of light on the surface of the sinusoidal lens is focused and then de-focused to a known diameter. The preferred diameters would be 4.5 mm for use with a 0.100 inch thick blade or 4.25 mm for use with a 0.125 inch thick blade, both being conventional blades.

Kerf illumination of the present invention clearly illuminates the width of the kerf as well as sharply defines the end surfaces of the workpiece on both sides of the blade. This eliminates the need to remember which side of the blade to place and align the “good” piece or measured piece of wood or other material.

The illuminated beam of light on the kerf location allows cutting a good piece of wood or other material on either side of a saw blade.

The illumination is projected as a widening beam or fan of light of fixed width. This is accomplished by the use of a lens having a surface with a sinusoidal wave pattern. The sinusoidal surface broadens the beam of light in one direction while maintaining the width of the beam in a second direction. The width dimension of the beam of light or fan of light therefore is constant without regard to the distance at which the beam or fan of light illuminates the work piece.

This Summary of the Invention is provided to summarize the various aspects of the invention and is not intended to limit the invention in any manner.

### BRIEF DESCRIPTION OF THE DRAWINGS

FIG. 1 is an illustration of a portion of a power miter saw with the invention installed on the frame.

FIG. 2 is an illustration of a portion of a power compound miter saw with the invention installed on the frame.

FIG. 3 is an illustration of a portion of a radial arm saw with the invention installed on the frame.

FIG. 4 is an exploded perspective illustration of the marking and illuminating device.

### DETAILED DESCRIPTION OF THE BEST MODE OF THE PREFERRED EMBODIMENTS OF THE INVENTION AS CONTEMPLATED BY THE INVENTOR

Initially referring to FIG. 1 of the drawings, the power miter saw 10 is illustrated with the invention mounted thereon.

The stage 12 of the deck 14 of the power miter saw 10 is set to make a cut near an end 16 on a workpiece 18. The stage 12 of the deck 14 is rotated to a preselected angle and locked into position. The external box 20 containing the illumination assembly (not shown) is attached to the frame 22 of the stage 12 of the miter saw 10 so as to move with the miter saw blade 13. Box 20 is oriented with the axis of the fanned light beam 24 extending toward the workpiece 18 and the aperture 100 of the illumination box 20 positioned with the long axis of the aperture 100 transverse to the plane of the saw blade 13.

The fanned light beam 24 is projected from the box 20 and onto the workpiece 18 so that the fanned light beam 24 illuminates the location of the kerf 25 that will be formed in the workpiece 18 whenever the miter saw teeth 26 of saw blade 13 engage with the workpiece 18.

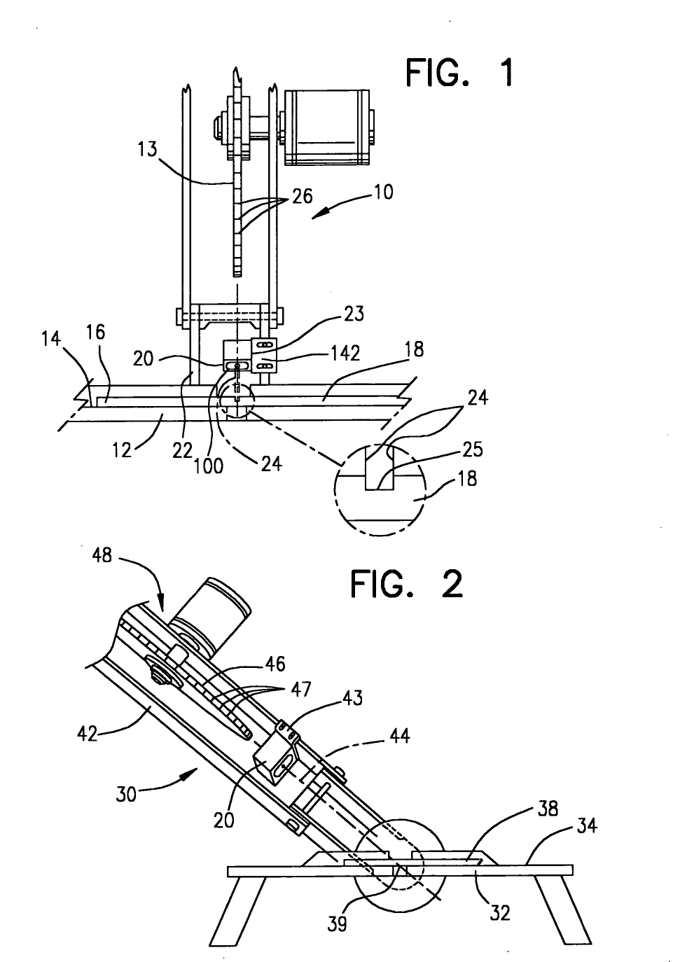

Referring to FIG. 2 of the drawings, the compound power miter saw 30 is illustrated with the invention incorporated therein.

The stage 32 of the deck 34 of the compound miter saw 30 is set to cut a compound angular cut 39 in the workpiece 38. Stage 32 of the deck 34 is rotated, and the frame 42 is inclined to provide the desired compound angular cut 39.

The illumination box 20 containing the illumination assembly 80 (not shown in FIG. 2) is adhesively attached to the frame 42 supporting the saw head 48 of the compound miter saw 30. Frame 42 is supported on the stage 32 and is oriented to have the same angular relationship to the workpiece 38 as does saw blade 46 with saw teeth 47. Thus, an illuminating device contained within box 20 projects a fanned line of light 44 co-planar with the saw blade 46.

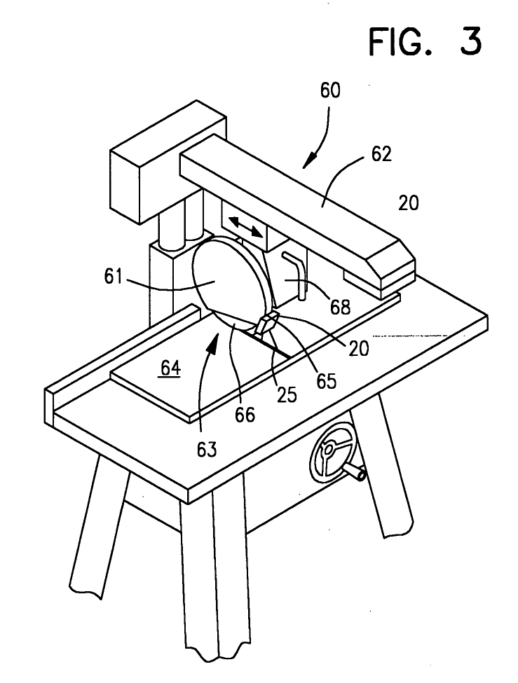

In FIG. 3, the invention is incorporated onto a radial arm 62 of a radial arm saw 60. The point of attachment of the illuminating device typically is at a point on the upper fixed blade guard 61. The mounting point does not cause an obstruction to the fanned light beam 24 as it is projected toward the workpiece 64 and permits free movement of the saw head 63. Workpiece 64 is illuminated at the location of the kerf 25 that will be formed whenever the saw head 63 is moved along the radial arm to place the saw blade 66 in engagement with the workpiece 64.

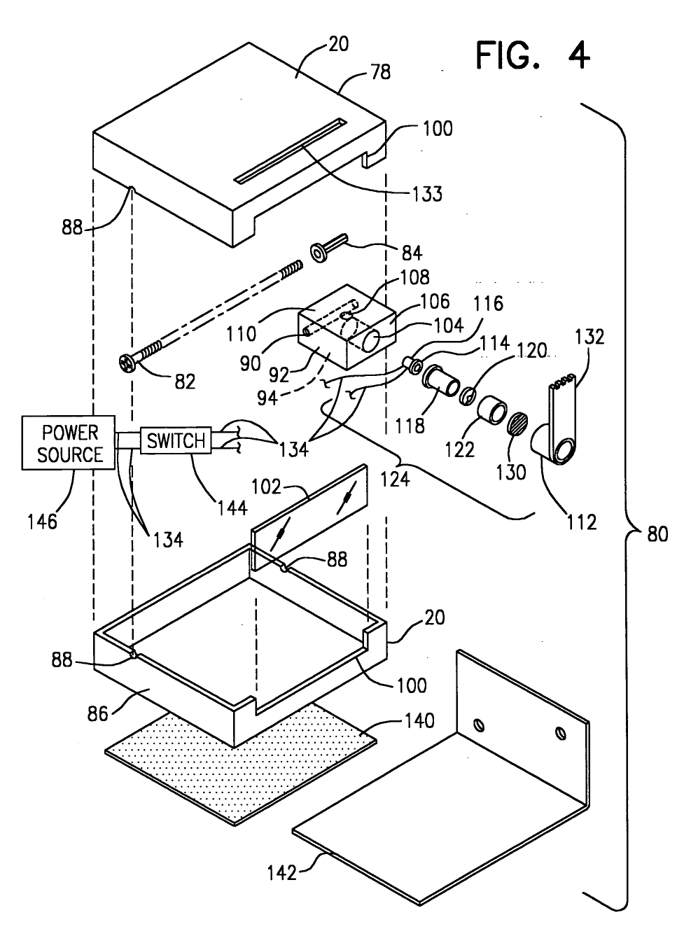

Referring to FIG. 4, an illumination assembly 80 is illustrated in an exploded depiction. The illumination box 20 is formed as an open shell to accommodate the laser light assembly 124, a lead screw 82 and nut 84. Both the top portion 78 and bottom portion 86 of illumination box 20 are provided with a pair of notches 88 that will accept the lead screw 82 as well as confine it once illumination box 20 is fully assembled.

The lead screw 82 is threadedly engaged with a threaded hole 90, which is transverse to the follower nut 92 which, in turn, is provided and moved along the axis of lead screw 82 by rotation of the lead screw 82. The movement of the follower nut 92 is confined against rotation within the illumination box 20 and thus rides with the undersurface 94 of follower nut 92 in contact with the interior of the top and bottom portions of illumination box 20. The end of barrel 112 engages the rear surface of the glass plate 102 and arm 132 extends outwardly through slot 133 in the top portion of illumination box 20.

The illumination box 20 is provided with an opening 100 from which the fanned light beam 24 (as shown in FIGS. 1, 2 and 3) may project. This aperture 100 is closed to outside conditions by a glass or transparent plate 102 installed in the end of the illumination box 20 adjacent opening 100.

Follower nut 92 is provided with a blind hole 104 formed in its front face 106 and having an opening 108 extending to the surface 110 of follower nut 92. Alignment collar 112 surrounds collar 122 which, in turn, surrounds laser 114 and the outer end of inner collar 118. The blind hole 104 is sized to permit the alignment collar 112 or orientation barrel 112 to slide into the blind hole 104.

The laser 114 and its attached supporting electronics 116 are positioned to align with collar 118 which has a focusing lens 120 permanently lodged on or within the collar 118. The laser 114 is inserted within the collar 118 and moved axially to the collar 118. This movement can be observed as changing the focus of the laser light such that a spot of light emanating from the focusing lens 120 grows or diminishes as the movement occurs. The spot size of light is adjusted by an “in-or-out” movement of laser 114 to focus and then to de-focus the spot of light relative to lens 120 until the spot is the proper size.

The spot size of the laser beam is sized to 4.5 mm or 4.25 mm depending upon the width of a saw blade 13, 46, 66 used on the appropriate saw 10, 30, 60. The spot size of the laser beam may be set to any width desired, depending upon the width of the saw kerf 25 formed by a blade 13, 46, 66. The width of the saw blade 13, 46, 66 is the width of the teeth 26, 37, 67 or the set of the teeth 26, 37, 67 measured perpendicular to the plane of the saw blade 13, 46, 66. Alternatively, saw blade 13, 46, 66 may be used to cut a kerf 25 in a piece of wood; then, the width of the kerf 25 is measured from edge to edge.

In all instances, the illumination assembly 80 should be positioned so that the laser light assembly 124 may be moved perpendicular to the plane of the saw blade 13, 46, 66 by the lead screw 82.

Once the spot of light is determined to be the proper size, 4.5 mm or 4.25 mm or other desired width, the laser 114, attached collar 118, and focusing lens 120 are potted or adhered to the interior of the barrel 122 by the use of a silicone adhesive or other type adhesive. This fixes the spot size. Barrel 122 provides an external surface which fits within orientation barrel 112.

The laser light assembly 124 is now ready to be inserted into the orientation barrel 112. The orientation barrel 112 is provided with a spot widening lens 130, and the lens 130 is potted or adhered with a silicone or other adhesive to the orientation barrel 112. The barrel 112 is connected or encircled with an arm 132 which is provided to permit rotation of the barrel 112 and lens 130. Arm 132 provides an easy manually engageable member to use to rotate the barrel 112 and, in turn, rotate the line or fanned light beam 24 that emanates from the widening lens 130.

The laser light assembly 124 and barrel 112 containing lens 130 are assembled and inserted into the blind hole 104 in follower nut or block 92 with the electrical leads 134 extended outwardly from the blind hole 104 through passage 108.

Lead screw 82 is threadedly engaged into both block 92 and end nut 84. The lead screw 82 and the end nut 84 are affixed to each other with an adhesive material to form a snug fit against the side of the illumination box 20 after nut 84 is tightened.

The block 92 then is laid in the illuminator box 20 and lead screw 82 is engaged with the notches 88 in the side walls of the container 20.

With the glass pane 102 inserted in the box 20 to close the window 100, the cover or top portion 78 of illumination box 20 is lowered onto the bottom portion 86 of box 20, and the two portions of the box 20 are adhered together.

The installation of the invention is accomplished by use of a pad of solid adhesive tape 140 with adhesive surfaces on both sides. The adhesive tape 140 is adhered to the mounting point 23, 43, 65 on the respective saws 10, 30, 60 in FIGS. 1-3. If the frame 22, 42, 62 at the desired point of attachment does not permit the location of the illumination box 20 to be oriented with the axis of the lead screw 82 orthogonal to the plane of the saw blade 13, 46, 66, the illumination box 20 may be mounted on a bracket 142 attached to the frame 22, 42, 62 to provide the mounting desired. Alternate shapes of the bracket 142 may be used, if desired, to properly orient the illumination box 20 and its contents.

Both nut 84 and lead screw 82 are rotated to translate the follower nut 92 with laser light assembly 124 and barrel 112 used to align the fanned light beam 24 with the saw blade 13, 46, 66. Once aligned laterally, the light fan or fanned light beam 24 is rotated, by orientation barrel 112 and its widening or fanning lens 130, to precisely illuminate the kerf 25 of the saw 10, 30, 60 by rotation of a lever or arm 132 to rotate the barrel 112 and the sinusoidal lens 130. Thus, the fanned light beam 24 of the device is co-located with the kerf 25 of the saw 10, 30, 60 and may be used to position a workpiece 18, 38, 64 such that the illuminated mark and the kerf 25 are exactly in the proper position relative to the workpiece 18, 38, 64.

The laser 114 is controlled by a switch 144 and a power source 146. The switch is inserted in the lines 134 at a convenient location. The power source 146 may be either a battery pack of typically two 1.5 volt batteries or may be a transformer/AC to DC converter providing an output of 3.0 volts DC.

The disclosure contains references to a laser unit. It should be understood that a light source, properly fed through a series of lenses to produce a beam of light which is not divergent, could be substituted for the laser in this invention, providing that there is sufficient room to accommodate the structure while at the same time to provide a spot of light that may be further manipulated into a fan of light having a uniform width and a substantial length. The fan of light must be rotatable to align with and illuminate the kerf of the saw on a workpiece.

This invention and the parts and subassemblies thereof have been described as the preferred embodiment of the invention. It should be understood that modifications and changes to the design of the device may be made by one of skill in the art if desired without changing the invention and these changes are contemplated to be included in the invention as claimed.

The laser used herein is available from Super Energy Corporation of Taipei, Taiwan.

This Detailed Description of the Invention is provided to enable one of ordinary skill in the art the necessary information to practice the invention and does not include all possible modifications and changes that may be made to the invention. The Detailed Description of the Invention is provided for the disclosure of the invention and is not intended to limit the scope of the invention in any manner.

Those of ordinary skill in the art may recognize and change certain aspects of and make modifications to the invention without removing the resulting combination from the scope of the claims.

1. A power saw with a cutting line indicator comprising:
a rotary saw comprising a base;
a frame attached to said base and movable with respect to said base;
a motor carried by said frame;
a rotary saw blade supported upon said motor and driven by said motor;
a cutting line indicator attached fixedly to said frame, said cutting line indicator comprising a container attached to said frame;
alignment means comprising a screw rotatably supported in said container and axially fixed with respect to said container and a threaded member engaged with said screw;
a lighting unit engaged with said threaded member for positioning with respect to said frame;
said lighting unit comprising a light source and a lens disposed to project a spot of light outward therefrom;
said spot of light fixed to a width dimension that is substantially equal to the width of said saw blade
a second lens rotatably supported relative to said light source;
said second lens containing a plurality of lens surfaces thereon to re-form said projected light spot into a line of light having a fixed width and an elongated length;
whereby said light source may be shifted sideways to align the light source with said rotary saw blade and said second lens is rotatable about said spot of light to rotate said elongated line of light to align said line of light with a kerf formed by said saw blade.

2. The power saw and cutting line indicator of claim 1 wherein said line of light is positioned directly below and illuminates a width to equal said rotary saw blade width.

3. The power saw and cutting line indicator of claim 1 wherein said second lens comprises a first surface having corrugations in the form of a sinusoidal curve and a second surface being planar to form the line of light emanating therefrom.

4. The power saw and cutting line indicator of claim 3 wherein said line of light is produced by a laser light unit.

5. The power saw and cutting line indicator of claim 4 wherein said light source is disposed at a distance from said first lens to produce a spot of light which when passed through said second lens produces said light line.

6. The power saw and cutting line indicator of claim 5 wherein said light source is powered by an electrical connection to a battery.

7. The power saw and cutting line indicator of claim 5 wherein said light source is powered by an electrical connection to a source of alternating current.

8. The power saw and cutting line indicator of claim 6 wherein said container is mounted on a portion of said frame with said axis of said screw being substantially parallel with an axis about which said motor and said saw blade is moved during a movement of said saw blade to bring said saw blade into contact with a workpiece being cut with said saw.

9. The power saw and cutting line indicator of claim 7 wherein said container is mounted on a portion of said frame with said axis of said screw being substantially parallel with an axis about which said motor and said saw blade is moved during a movement of said saw blade to bring said saw blade into contact with a workpiece being cut with said saw.

10. The power saw and cutting line indicator of claim 6 wherein said container is mounted on a portion of said fame with said axis of said screw being substantially orthogonal to the movement of said saw blade when moved to bring said saw blade into contact with said workpiece.

11. The power saw and cutting line indicator of claim 7 wherein said container is mounted on a portion of said frame with said axis of said screw being substantially orthogonal to the movement of said saw blade when moved to bring said saw blade into contact with said workpiece.
